(19) United States
(12) Patent Application Publication
(10) Pub. No.: US 2025/0102428 A1
(43) Pub. Date: Mar. 27, 2025

(54) METHOD OF MEASURING MOISTURE CONTENT OF LIGNOCELLULOSIC BIOMASS AND SAMPLE COMPRESSOR FOR MEASURING SAME

(71) Applicant: SEOUL NATIONAL UNIVERSITY R&DB FOUNDATION, Seoul (KR)

(72) Inventors: Hwanmyeong YEO, Seoul (KR); Sung-Wook HWANG, Seoul (KR); Taekyeong LEE, Seoul (KR); Myungsik CHO, Seoul (KR); In-Gyu CHOI, Seoul (KR); Hyo Won KWAK, Seoul (KR); Bat-uchral BATJARGAL, Seoul (KR)

(21) Appl. No.: 18/830,876

(22) Filed: Sep. 11, 2024

(30) Foreign Application Priority Data
Sep. 26, 2023 (KR) 10-2023-0129771

(51) Int. Cl. G01N 21/3554; G01N 1/28; G01N 21/01; G01N 21/359; G01N 21/84

(52) U.S. Cl. CPC G01N 21/3554; G01N 1/286; G01N 21/359; G01N 21/84; G01N 2021/0125; G01N 2021/8466

(57) ABSTRACT

Disclosed are a method of measuring moisture content of lignocellulosic biomass and sample compressor for measuring the same. The method of measuring the moisture content of lignocellulosic biomass comprises: (a) supplying a sample containing a lignocellulosic biomass; (b) acquiring the near-infrared spectrum of the sample; (c) mathematical preprocessing of the near-infrared spectrum; (d) Regression analysis (PLSR) of the mathematically pretreated near-infrared line spectrum by partial least squares method to construct a moisture content prediction model; and (e) obtaining the moisture content of the sample using the moisture content prediction model. According to the present disclosure, there is no data variation according to the density of the sample, the amount of the sample is not reduced because there is no sample collection for density measurement, and it is non-destructive and has the effect of quickly measuring the moisture content.

### CROSS REFERENCE TO RELATED APPLICATION

The present application claims priority to Korean Patent Application No. 10-2023-0129771, filed Sep. 26, 2023, the entire contents of which is incorporated herein for all purposes by this reference.

### BACKGROUND OF THE DISCLOSURE

### 1. Field of the Disclosure

The present disclosure relates to a method of measuring moisture content of lignocellulosic biomass and sample compressor for measuring the same.

### 2. Description of the Related Art

As of 2022, the supply of unused forest biomass in Korea reached 1.18 million tons and the amount of use reached 1.17 million tons (Unused Forest Biomass Supply, Usage, Korea Forest Service, 2023). Climate change and carbon neutrality are the biggest concerns of humanity at present, and in Korea's ‘2050 Carbon Neutrality Scenario’, energy supply and fuel conversion in the industrial sector account for most of the emission reduction. The supply and utilization of unused forest biomass is increasing rapidly in view of the efficient use of forest resources and the realization of a circular economy by utilizing discarded resources as an energy source, and the demand for unused forest biomass is expected to continue to increase as environmental issues emerge in the future.

The Korea Forest Service is promoting the ‘Unused Forest Biomass’ system to promote the energy utilization of forest biomass (Regulations on the Use, Distribution, and Promotion of Forest Biomass Energy, Korea Forest Service). The market size of wood pellets based on unused forest biomass more than doubled from 240,000 tons in 2019 to 510,000 tons in 2021, accounting for 14% of the total domestic market (Status and Implications of Unused Forest Biomass Utilization, National Institute of Forest Science). As such, the size of the unused forest biomass market continues to grow.

In the use of unused forest biomass and sweet sorghum, moisture content control is the most important factor for the storage of unused forest biomass and sweet sorghum, which have the characteristic of being easily deteriorated.

Therefore, there is a need for a non-destructive, fast and accurate moisture content measurement method that can measure the moisture content of lignocellulosic biomass such as unused forest biomass and sweet sorghum with a low construction cost and a simple process.

In addition, Korean Publication No. 10-2019-0098558 was disclosed as a prior art patent.

### SUMMARY OF THE DISCLOSURE

The purpose of the present disclosure is to solve the above problems and to provide a method of measuring the moisture content of lignocellulosic biomass quickly and accurately using the near-infrared spectrum.

The other purpose of the present disclosure is to provide a sample compressor for measuring the moisture content of lignocellulosic biomass by a non-destructive, simple process that can be applied directly to a sample and compressed to obtain the near-infrared spectrum without the need for a separate sample.

According to one aspect of the present disclosure, there is provided a method of measuring the moisture content of lignocellulosic biomass, the method comprising: (a) supplying a sample containing a lignocellulosic biomass; (b) acquiring a near-infrared spectrum of the sample; (c) mathematically preprocessing the near-infrared spectrum; (d) constructing a moisture content prediction model by performing regression analysis on the preprocessed near-infrared spectrum with partial least square regression (PLSR); and (e) obtaining a moisture content of the sample using the moisture content prediction model.

In addition, the lignocellulosic biomass may comprise a fragmented lignocellulosic biomass.

In addition, the lignocellulosic biomass may comprise one or more types selected from the group consisting of logging residue and sweet sorghum.

In addition, the step (c) may comprise: (c-1) obtaining a second derivative spectrum data by applying a second-derivative method to the near-infrared spectrum.

In addition, step (c) may further comprise: (c-2) taking measured wavelength gap (nm) of the near-infrared spectrum as any one of 1 to 10 nm and smoothing the near-infrared spectrum, wherein the step (c-2) is performed after the step (c-1).

In addition, the smoothing may be performed using moving average method with 11 points.

In addition, the step (d) may comprise: (d-1) obtaining a moisture content prediction model by performing regression analysis on mathematically preprocessed near-infrared spectrum with partial least squares regression (PLSR) method; and (d-2) constructing a verified moisture content prediction model by validating the moisture content prediction model.

In addition, the verifying of the step (d-2) can be performed by K-fold cross validation.

In addition, the number of folds in step (e) may be in a range of 2 to 6.

In addition, the wavelength range of the obtained spectral data may be in a range of 1250 to 2300 nm.

In addition, the method may further comprise: (a′) compressing the lignocellulosic biomass to prepare a compacted lignocellulosic biomass with a predetermined density, wherein the step (a′) is performed before the step (a).

In addition, the density may be in a range of 0.1 to 0.5 g/cm³.

In addition, the method may further comprise: (b′) the procedure to obtain the corrected spectrum data by deleting outlier from the near-infrared spectral data, wherein the step (b′) is performed after the step (b).

In addition, the outlier of step (b′) may be data that does not belong to a cluster and exists outside of the cluster in principal component analysis (PCA).

In addition, the outlier may be due to an incomplete contact between the near-infrared probe 210 of the near-infrared meter and the sample failed to contact each other.

According to another aspect of the present disclosure, there is provided a sample compressor 10 for measuring a moisture content of lignocellulosic biomass comprising: a compression part 100 which has cylinder shape, and comprises a body 120 with a hollow 110 oriented longitudinally; a detection part 200 which is longitudinally oriented in the middle of the body 120, and comprises a near-infrared probe 210; and a plurality of sample fixing parts 300 which are located inside of the hollow 110 and are oriented longitudinally around the detection part 200.

In addition, the body 120 may comprise a through hole 130 which penetrates the hollow 110 and outside thereof, and the sample fixing part comprises a piston 310, a spring 320 and a fixing pin 330.

In addition, the piston 310 may comprise a protrusion 311, and the spring 320 is compressed when the piston 310 moves into the direction of the sample containing the lignocellulosic biomass, and the protrusion 311 may be drawn into the through hole 130, and fixed.

In addition, the sample fixing parts 300 may be moved in the opposite direction of the direction of the sample by elastic force of the spring 320 when the protrusion 311 is discharged from the trough hole 130 and jam is removed.

In addition, the fixing pin 330 may be connected to one end of the piston 310, and is longitudinally located in the internal hollow 110 of the spring 320.

In addition, the spring 320 may be impregnated in the lignocellulosic biomass, and fix the lignocellulosic biomass when the spring 320 is compressed.

In addition, the near-infrared probe 210 may comprise a light source fiber 211 and a light absorbing fiber 212, and the light absorbing fiber 212 to absorb the light reflected from the sample.

The moisture content measurement method of the biomass of the present disclosure does not have data variation according to the density of the sample, does not reduce the amount of the sample because no sample is collected for density measurement, and has the effect of measuring the moisture content non-destructively and quickly.

### BRIEF DESCRIPTION OF THE DRAWINGS

Since the accompanying drawings are for reference in describing exemplary Examples of the present disclosure, the technical spirit of the present should not be construed as being limited to the accompanying drawings, in which:

FIG. 1 is a flow diagram showing a method of measuring the moisture content of lignocellulosic biomass according to Example 3 of the present disclosure;

FIG. 2 is a schematic diagram showing the configuration of a sample compressor 10 for the determination of the moisture content of lignocellulosic biomass according to Example 3 of the present disclosure;

FIG. 3A is an image of a logging residue specimen for the moist content measurement of the present disclosure, and FIG. 3B is an image of a sweet sorghum table pattern for the moist content measurement of the present disclosure;

FIG. 4A is a flow chart showing a method of measuring the moisture content of lignocellulosic biomass using a commercial wood moisture meter according to Example 1 of the present disclosure, FIG. 4B is a flow chart showing a method of measuring the moisture content of a lignocellulosic biomass using an electrical resistance method according to Example 2 of the present disclosure, and FIG. 4C is a flow chart showing a method of measuring the moisture content of a lignocellulosic biomass using a near-infrared line spectrum according to Example 3 of the present disclosure;

FIG. 5 is a schematic diagram of a K-fold cross-verification for constructing a model for measuring the moisture content of a lignocellulosic biomass material according to Example 3 of the present disclosure;

FIG. 6A is a graph showing the moisture content of the lignocellulosic biomass measured by the oven drying method according to Example 1 of the present disclosure, FIG. 6B is a graph showing the mean square root error of the moisture content of the lignocellulosic biomass measured with a moisture content meter for the moisture content of the lignocellulosic biomass measured by the oven drying method according to Example 1 of the present disclosure, FIG. 6C is a graph comparing the moisture content of the logging residue measured with the oven drying method and the moisture content meter according to the Example 1 of the present disclosure, and FIG. 6D is a graph comparing the moisture content of sweet sorghum measured by the oven drying method and the moisture content meter;

FIG. 7A is a graph showing the moisture content through the oven drying of the logging residue according to the Example 1 of the present disclosure, the moisture content through the moisture content meter and the moisture content through the moisture content meter to which the correction factor is applied, and FIG. 7B is a graph showing the moisture content through the oven drying of the sweet sorghum according to the Example 1 of the present disclosure, the moisture content through the moisture content meter and the moisture content through the moisture content meter at the bulk density 0.32 g/cm³;

FIG. 8A is a graph dividing the electrical resistance of logging residue at 10° C. according to Example 2 of the present disclosure, FIG. 8B is a graph showing the electrical resistance of a sweet sorghum at 10° C. according to Example 2 of the present disclosure, FIG. 8C is a graph showing the change in the electrical resistance of the logging residue due to an increase in the volume density according to Example 2 of the present disclosure and the relation of the moisture content and electrical resistance, and FIG. 8D is a graph showing the change in the electrical resistance of sweet sorghum and the relationship between moisture content and electrical resistance according to the increase in volume density according to Example 2 of the present disclosure;

FIG. 9A is a graph showing the near-infrared spectrum of a sample of logging residue compressed to a bulk density of 0.32 g/cm³ at 20° C. in the domain of 1250 to 2300 nm according to Example 3 of the present disclosure, FIG. 9B is a graph showing the near-infrared spectrum of a sample of sweet sorghum compressed to a bulk density of 0.32 g/cm³ at 20° C. in the region of 1250 to 2300 nm according to Example 3 of the present disclosure, FIG. 9C is a graph showing the Euclidean distance between the near-infrared spectra measured three times at the angular density of logging residues according to Example 3 of the present disclosure, and FIG. 9D is a graph showing the Euclidean distance between the near-infrared spectra measured three times at each density of sweet sorghum according to Example 3 of the present disclosure;

FIG. 10A is a graph representing a pair plot of the principal component (PC) scores clustered by DBSCAN for near-infrared data with outliers of logging residue according to Example 3 of the present disclosure, and FIG. 10B is a graph representing a pair plot of the principal component (PC) scores clustered by DBSCAN for near-infrared data with outliers of sweet sorghum according to Example 3 of the present disclosure. In FIGS. 10a and 10b, the percentage values in parentheses of axis headings signify the dispersion factor of PC;

FIG. 11A is a graph dividing the near-infrared (NIR) spectra of logging residue according to Example 3 of the present disclosure and the main component analysis (PCA) score plots of the two PCs at the loading of the first PC for the two materials, FIG. 11B is a graph representing the near-infrared (NIR) spectra of the sweet sorghum according to example 3 of the present disclosure and the main component analysis (PCA) score plot of the two PCs at the loading of the first PC for the two materials, and FIG. 11C is a graph showing the loading of the first PC by near-infrared wavelength of logging residue and sweet sorghum according to Example 3 of the present disclosure; and

FIG. 12A is a graph showing the scatter plot of the moisture rate measured by the oven drying method at 10° C. for the sweet sorghum moisture prediction model constructed with near-infrared data according to Example 3 of the present disclosure, and FIG. 12B is a graph showing the scatter plot of the moisture content predicted by the partial least squares regression analysis (PLSR) model at 10° C. for no outliers according to Example 3 of the present disclosure. For reference, R²c is the coefficient of determination for calibration, RMSEC is the root mean square error of calibration, R²p is the predictive determination factor, RMSEP is the square root error for prediction, and outliers are statistical observations that are distinct from the rest of the sample.

### DESCRIPTION OF THE PREFERRED EXAMPLES

Herein after, examples of the present disclosure will be described in detail with reference to the accompanying drawings in such a manner that the ordinarily skilled in the art can easily implement the present disclosure.

The description given below is not intended to limit the present disclosure to specific Examples. In relation to describing the present disclosure, when the detailed description of the relevant known technology is determined to unnecessarily obscure the gist of the present disclosure, the detailed description may be omitted.

The terminology used herein is for the purpose of describing particular Examples only and is not intended to limit the scope of the present disclosure. As used herein, the singular forms “a”, “an”, and “the” are intended to include the plural forms as well unless the context clearly indicates otherwise. It will be further understood that the terms “comprise” or “have” when used in this specification specify the presence of stated features, integers, steps, operations, elements and/or combinations thereof, but do not preclude the presence or addition of one or more other features, integers, steps, operations, elements, and/or combinations thereof.

Terms including ordinal numbers used in the specification, “first”, “second”, etc. can be used to discriminate one component from another component, but the order or priority of the components is not limited by the terms unless specifically stated. These terms are used only for the purpose of distinguishing a component from another component. For example, without departing from the scope of the present disclosure, a first component may be referred as a second component, and a second component may be also referred to as a first component.

In addition, when it is mentioned that a component is “formed” or “stacked” on another component, it should be understood such that one component may be directly attached to or directly stacked on the front surface or one surface of the other component, or an additional component may be disposed between them.

Hereinafter, a method of measuring moisture content of lignocellulosic biomass and sample compressor for measuring the same will be described in detail. However, those are described as examples, and the present disclosure is not limited thereto and is only defined by the scope of the appended claims.

According to one aspect of the present disclosure, there is provided a method of measuring the moisture content of lignocellulosic biomass, the method comprising: (a) supplying a sample containing a lignocellulosic biomass; (b) acquiring a near-infrared spectrum of the sample; (c) mathematically preprocessing the near-infrared spectrum; (d) constructing a moisture content prediction model by performing regression analysis on the preprocessed near-infrared spectrum with partial least square regression (PLSR); and (e) obtaining a moisture content of the sample using the moisture content prediction model.

In addition, the lignocellulosic biomass may comprise a fragmented lignocellulosic biomass.

In addition, the lignocellulosic biomass may comprise one or more types selected from the group consisting of logging residue and sweet sorghum.

In addition, the step (c) may comprise: (c-1) obtaining a second derivative spectrum data by applying a second-derivative method to the near-infrared spectrum.

In addition, step (c) may further comprise: (c-2) taking measured wavelength gap (nm) of the near-infrared spectrum as any one of 1 to 10 nm and smoothing the near-infrared spectrum, wherein the step (c-2) is performed after the step (c-1).

In addition, the smoothing may be performed using moving average method with 11 points.

In addition, the step (d) may comprise: (d-1) obtaining a moisture content prediction model by performing regression analysis on mathematically preprocessed near-infrared spectrum with partial least squares regression (PLSR) method; and (d-2) constructing a verified moisture content prediction model by validating the moisture content prediction model.

In addition, the verifying of the step (d-2) can be performed by K-fold cross validation.

In addition, the number of folds in step (e) may be in a range of 2 to 6, preferably 4 or 6. When the number of folds is smaller than 2, the number of data is not secured and statistics are not possible. When the number of folds is larger than 6, the number of data becomes unnecessarily large, and the increase in accuracy is insignificant. Therefore, the number of folds smaller than 2 or larger than 6 is not desirable.

In addition, the wavelength range of the obtained spectral data may be in a range of 1250 to 2300 nm.

In addition, the method may further comprise: (a′) compressing the lignocellulosic biomass to prepare a compacted lignocellulosic biomass with a predetermined density, wherein the step (a′) is performed before the step (a).

In addition, the density may be in a range of 0.1 to 0.5 g/cm³, preferably a range of 0.2 to 0.5 g/cm³, preferably a range of 0.3 to 0.5 g/cm³. When the density is smaller than 0.1 g/cm³, it is difficult to secure the near-infrared spectrum due to the large amount of empty space of the lignocellulosic biomass. When the density is larger than 0.5 g/cm³, it is difficult to compress by the air layer that exists outside and inside the cell wall that constitutes the lignocellulosic biomass. Therefore, the density smaller than 0.1 g/cm³ or larger than 0.5 g/cm³ is not desirable.

In addition, the method may further comprise: (b′) the procedure to obtain the corrected spectrum data by deleting outlier from the near-infrared spectral data, wherein the step (b′) is performed after the step (b).

In addition, the outlier of step (b′) may be data that does not belong to a cluster and exists outside of the cluster in principal component analysis (PCA).

In addition, the outlier may be due to an incomplete contact between the near-infrared probe 210 of the near-infrared meter and the sample failed to contact each other.

According to another aspect of the present disclosure, there is provided a sample compressor 10 for measuring a moisture content of lignocellulosic biomass comprising: a compression part 100 which has cylinder shape, and comprises a body 120 with a hollow 110 oriented longitudinally; a detection part 200 which is longitudinally oriented in the middle of the body 120, and comprises a near-infrared probe 210; and a plurality of sample fixing parts 300 which are located inside of the hollow 110 and are oriented longitudinally around the detection part 200.

In addition, the body 120 may comprise a through hole 130 which penetrates the hollow 110 and outside thereof, and the sample fixing part comprises a piston 310, a spring 320 and a fixing pin 330.

In addition, the piston 310 may comprise a protrusion 311, and the spring 320 is compressed when the piston 310 moves into the direction of the sample containing the lignocellulosic biomass, and the protrusion 311 may be drawn into the through hole 130, and fixed.

In addition, the sample fixing parts 300 may be moved in the opposite direction of the direction of the sample by elastic force of the spring 320 when the protrusion 311 is discharged from the trough hole 130 and jam is removed.

In addition, the fixing pin 330 may be connected to one end of the piston 310, and is longitudinally located in the internal hollow 110 of the spring 320.

In addition, the spring 320 may be impregnated in the lignocellulosic biomass, and fix the lignocellulosic biomass when the spring 320 is compressed.

In addition, the near-infrared probe 210 may comprise a light source fiber 211 and a light absorbing fiber 212, and the light absorbing fiber 212 to absorb the light reflected from the sample.

In addition, the compacted portion and the detection unit may be to compress the lignocellulosic biomass.

### EXAMPLE

Hereinafter, a preferred example of the present disclosure will be described. However, the example is for illustrative purposes, and the scope of the present disclosure is not limited thereto.

### Preparation Example 1: Samples and Humidification

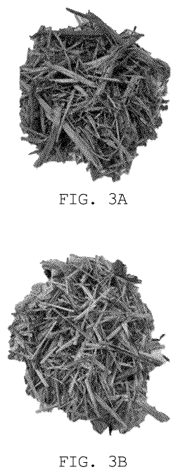

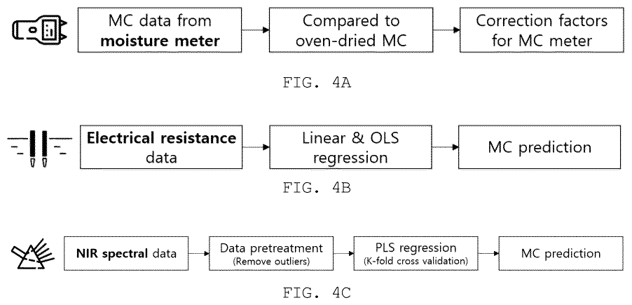

FIG. 3A is an image of a logging residue specimen for the moist content measurement of the present disclosure, and FIG. 3B is an image of a sweet sorghum specimen for the moist content measurement of the present disclosure. And Table 1 shows the details of the lignocellulosic biomass samples tested. Referring to FIGS. 3A, 3B and Table 1, logging residues and sweet sorghum (Sorghum bicolor var. dulciusculum) were used as the biomass material for moisture determination. Specimens of 10 g of each of the materials were used in all experiments. Logging residues comprised comminuted amorphous lignocellulosic fragments, also called hog fuel, and residues left at the site after timber harvesting operations. The bulk densities of both materials were lower than those of reported values due to their long particle size and origin, resulting in low biomass characteristics index (BCI).

TABLE 1

| | Particle | Bulk Density | | |
|---|---|---|---|---|
| Biomass | Size (mm) | (g/cm³) | MC (%) | BCI |
| Logging | 4.8 to 103.9 | 0.125 | 11.6 | 11,050 |
| residue | | | | |
| Sweet | 22.2 to | 0.103 | 11.0 | 9,167 |
| sorghum | 131.7 | | | |

Table 2 below is a table showing the environmental conditions and corresponding equilibrium moisture content of the lignocellulosic biomass of the present disclosure. Referring to Table 2, for moisture level adjustment, the samples were conditioned stepwise in a climate chamber (HB-105MP. Hanbaek Scientific Co., Bucheon-si, Korea) at predefined temperatures and relative humidity (RH) values, as listed in Table 2. The climatic conditions tested corresponded to the equilibrium moisture content (EMC) range of 5.2 to 24.3%. After all humidification cycles were completed, the MC of the samples was determined using the oven drying method. The oven drying method was used as the reference method for MC determination.

TABLE 2
Equilibrium Moisture Content (%)

| | Temperature (° C.) | | |
|---|---|---|---|
| RH (%) | 10 | 20 | 30 |
| 25 | 5.5 | 5.4 | 5.2 |
| 40 | 7.9 | 7.7 | 7.5 |
| 60 | 11.2 | 11.0 | 10.6 |
| 80 | 16.4 | 16.0 | 15.5 |
| 95 | 24.3 | 23.9 | 23.4 |

### Preparation Example 2: Sample Compression for Data Acquisition

The charge transport path may be incomplete in the logging residue and sweet sorghum samples because the narrow and elongated fragments were sparsely aggregated. This structure causes unstable electrical resistance. Hence, the moisture in the biomass was measured for materials compressed by a cylinder. A plunger compressed 10 g of samples using a high-density polyethylene plate in a cylinder 45 mm in diameter. Moisture data were obtained using a wood moisture meter, megohmmeter, and NIR spectrometer when the bulk densities of the samples were 0.09, 0.11, 0.13, 0.16, 0.21, and 0.32 g/cm³.

Referring to Table 1, for logging residue, because the bulk density of the raw material was 0.125 g/cm³, it was compressed in the range of 0.13 to 0.32 g/cm³. In stepwise compression of both materials, the bulk density of the first stage is the uncompressed state. The data were acquired by drilling hole 130s in the end section of the compression cylinder, after which electrodes and an NIR probe were inserted.

All measurements were performed in a climate chamber to minimize moisture changes in the samples. As shown in FIGS. 4a to 4c, a commercial wood moisture meter, electrical resistance, and NIRS were employed for moisture measurement of the biomass materials. Moisture data of the samples were obtained from compressed materials using all the moisture determination methods when the samples reached a constant weight under each climatic condition.

### Example 1: Moisture Meter

FIG. 4A is a flow chart showing a method of measuring the moisture content of lignocellulosic biomass using a commercial wood moisture meter according to Example 1 of the present disclosure. Referring to FIG. 4A, an electrical resistance-based wood moisture meter (MC-460; Exotek Instruments, Fichtenberg, Germany) with a general-purpose 2-pin probe was used for MC measurement. The moisture meter was designed for moisture measurement in wood, boards, chips, cardboards, and pellets in the MC range of 3 to 140%; manual temperature compensation was also possible. Correction factors for the MC of logging residue and sweet sorghum determined by the moisture meter were calculated from the comparison between the MCs measured by the moisture meter and those measured by the oven-drying method.

### Example 2: Electrical Resistance Measures Based Moisture Content Measurement

FIG. 4B is a flow chart showing a method of measuring the moisture content of a lignocellulosic biomass using an electrical resistance method according to Example 2 of the present disclosure. Referring to FIG. 4B, the electrical resistance of the biomass materials was measured using two electrodes insulated with polytetrafluoroethylene except at the tip. The distance between the electrodes was 25 mm. To maintain this distance, electrodes were fixed to a probe (26-ES, Delmhorst Instrument Co., Towaco, NJ). Electrode penetration depth was adjusted for each bulk density to measure the MC at the center of the incylinder compressed samples.

A super megohmmeter (SM-8220, HIOKI E. E. Corp., Nagano, Japan) was used to measure the electrical resistance of the samples. The megohmmeter passed a constant direct current voltage into the sample, measured the current at that time, and calculated the electrical resistance from the relationship between the voltage, current, and resistance. Regression equations for MC prediction were calculated for each temperature condition tested using simple linear regression on electrical resistance and oven-drying-based MC measurements. Additionally, ordinary least squares regression (OLSR) models using the relationship among MC, temperature, and electrical resistance were built for MC prediction. The OLSR models were built using Python 3.8 with open-source libraries.

### Example 3: NIR Based Moisture Content Measurement

### NIR Based Sample Compressor for Moisture Measurement

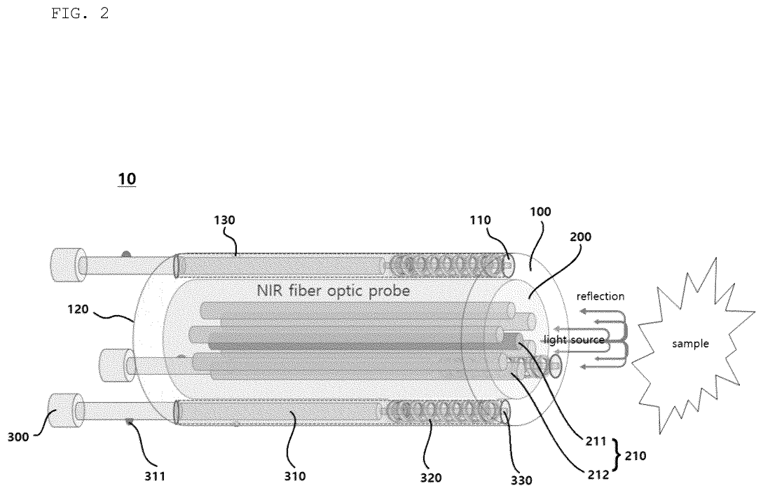

FIG. 2 is a schematic diagram showing the configuration of a sample compressor 10 for the determination of the moisture content of lignocellulosic biomass according to Example 3 of the present disclosure. Referring to FIG. 2, a sample compressor 10 with a ballpoint pen-type sample fixation structure was devised as a manufacturing method of the sample compressor 10. After pushing the near-infrared probe 210 into the sample, the ballpoint pen-type sample fixture is operated at the desired location to measure the moisture content, and the probe is pressed closer to the sample to reduce the gap between the probe and the sample.

The sample compressor for measuring a moisture content of lignocellulosic biomass comprises a compression part 100 which has cylinder shape, and comprises a body 120 with a hollow 110 oriented longitudinally; a detection part 200 which is longitudinally oriented in the middle of the body 120, and comprises a near-infrared probe 210; and a plurality of sample fixing parts 300 which are located inside of the hollow and are oriented longitudinally around the detection part.

### Spectral Dataset

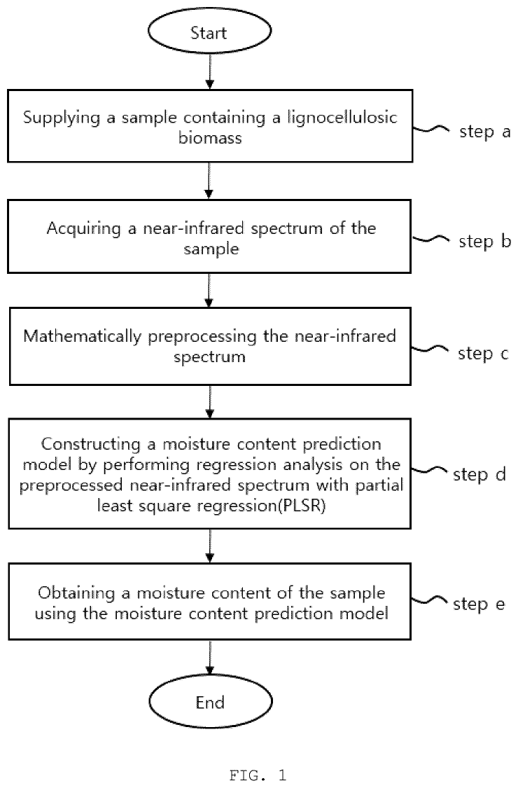

FIG. 1 is a flow diagram showing a method of measuring the moisture content of lignocellulosic biomass according to Example 3 of the present disclosure, and FIG. 4C is a flow chart showing a method of measuring the moisture content of a lignocellulosic biomass using a near-infrared line spectrum according to Example 3 of the present disclosure. Referring to FIG. 1 and FIG. 4C, NIR spectra were acquired from the biomass samples using an NIR spectrometer (NIR Quest, Ocean Insight, Orlando, FL, USA) equipped with a fiber optic probe with a scan diameter of 5 mm in reflection mode. The spectrum had a wavelength of 870 to 2500 nm with a spectral resolution of 6.6 nm and was the average of 16 scans. Because NIR characterizes shallow spots on the material surface, the spectra were measured three times at different points for each bulk density of the compressed material. Consequently, 180 spectra for the logging residue dataset and 270 spectra for the sweet sorghum dataset were collected for all climatic conditions, resulting in a database consisting of 450 NIR spectra. From the full wavelength range of 870 to 2500 nm, noisy and non-informative regions were eliminated so that all spectra had a wavelength ranging from 1250 to 2300 nm. Subsequently, the original spectra were transformed into second derivative spectra using a Savitzky-Golay filter (Savitzky and Golay 1964) with 11 points and a quintic polynomial. Such spectral selection and transformation may improve model performance by increasing data precision.

### Clustering

Principal component analysis (PCA) was performed to analyze the spectral changes in logging residues and sweet sorghum induced by moisture and bulk density variations. PCA transformed the 1250 to 2300 nm NIR spectra, as a 165-dimensional spectral vector, into 6 principal components (6-dimensional vector). Variations in data due to moisture changes were analyzed using principal component (PC) score plots and loadings.

Density-based spatial clustering of applications with noise (DBSCAN) (Ester et al. 1996; Zhang et al. 2004) was employed to detect outliers from the data points projected onto the PC orthogonal coordinate system. The DBSCAN clustering parameters epsilon (esp) and the minimum number of samples (min_samples) were empirically selected as 0.1 and 3, respectively. The parameter ‘esp’ is the distance of influence of data points to determine valid neighbors, and ‘min_samples’ is the minimum number of data points required to create a cluster. Three or more consecutive points within a distance of 0.1 from a data point are considered a cluster.

### Partial Least Squares Regression (PLSR) Models

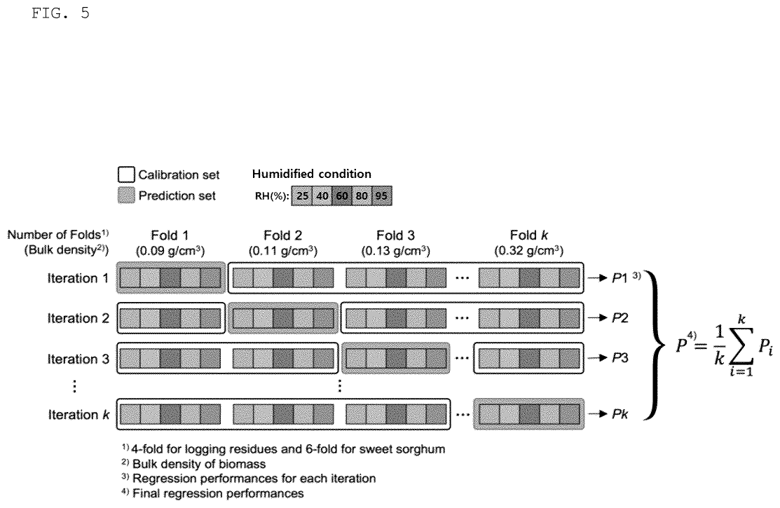

FIG. 5 is a schematic diagram of a K-fold cross-verification for constructing a model for measuring the moisture content of a lignocellulosic biomass material according to Example 3 of the present disclosure. Referring to FIG. 5, partial least squares regression (PLSR) models (Abdi 2010) were built to predict the MC of the biomass materials. The models used the 165-dimensional NIR spectra as the input variables and MC as the output variable. The model was verified using k-fold cross validation. Data folds were created for each bulk density, resulting in four-fold data for logging residue and six-fold data for sweet sorghum. In other words, the datasets were divided into calibration and prediction sets at a ratio of 1:3 for logging residue and 1:5 for sweet sorghum. This data partitioning was intended to independently generate calibration and prediction sets by bulk density, and the coefficient of determination (R²) according to Equation 1 below and root-mean-square error (RMSE) according to Equation 2 were used as performance metrics for the PLSR models. The M, and M, below represent the measured and predicted moisture content of the ith observation, respectively, the parameter p is the overall average and n is the total number of observations.

$${R}^{2} = 1 - ( {\sum }_{i} {( {M}_{i} - {\hat{M}}_{i} )}^{2} / {\sum }_{i} {( {M}_{i} - μ )}^{2} ) \qquad [ Equation 1 ]$$

$$RMSE = \sqrt{\frac{1}{n} {\sum }_{i = 1}^{n} {( {\hat{M}}_{i} - {M}_{i} )}^{2}} \qquad [ Equation 2 ]$$

### EXPERIMENTAL EXAMPLE

### Experimental Example 1: Comparison of Moisture Content by Moisture Meter and Oven Drying

### Experimental Example 1-1: Moisture Content Analysis without Correction Factor Applied

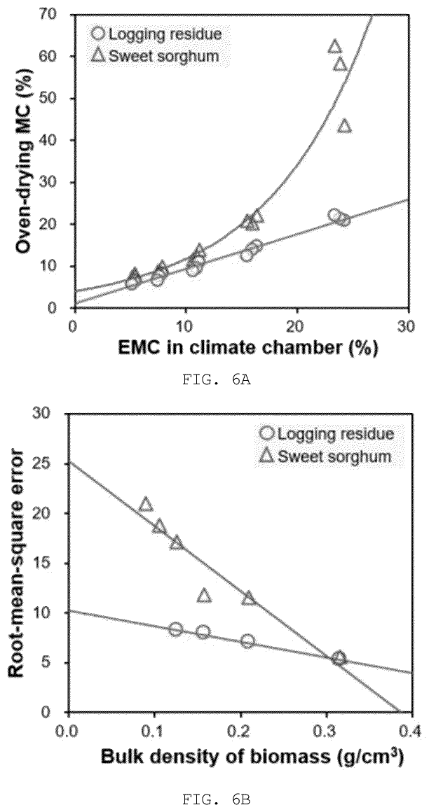

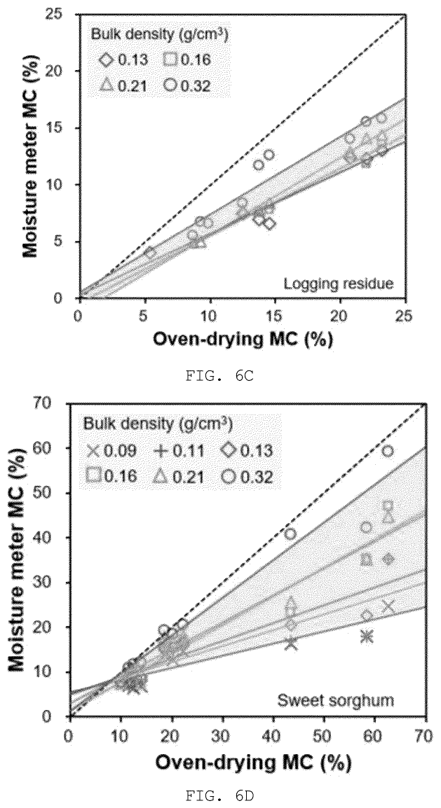

FIG. 6A is a graph showing the moisture content of the lignocellulosic biomass measured by the oven drying method according to Example 1 of the present disclosure, FIG. 6B is a graph showing the mean square root error of the moisture content of the lignocellulosic biomass measured with a moisture content meter for the moisture content of the lignocellulosic biomass measured by the oven drying method according to Example 1 of the present disclosure, FIG. 6C is a graph comparing the moisture content of the logging residue measured with the oven drying method and the moisture content meter according to the Example 1 of the present disclosure, and FIG. 6D is a graph comparing the moisture content of sweet sorghum measured by the oven drying method and the moisture content meter.

Referring to FIG. 6A, the relationship between the biomass MCs measured using the oven-drying method and the EMCs in the climate chamber differed depending on the material. The logging residue MCs were slightly lower than that of the in-chamber EMCs and showed a linear relationship. Contrastingly, the MC of sweet sorghum was higher than the EMC of the chamber and had an exponential regression line due to sweet sorghum absorbing excessive moisture above the fiber saturation point (FSP) during humidification at 95% RH. The high MC of sweet sorghum is attributed to its high proportion of hydrophilic components. Compared with wood, sweet sorghum has a low content of lignin (hydrophobic component) and a high hemicellulose content (hydrophilic component).

Also, referring to FIG. 6B, increasing the bulk density of the materials decreased the RMSEs between the MCs and oven-drying MCs, which suggests that creating a material with a high bulk density is advantageous for reliable moisture determination. In addition, referring to FIGS. 6C and 6D, the importance of material compression can also be seen in that the MCs approach oven-drying MCs at higher bulk densities. Since the loose compression of lignocellulosic biomass samples interferes with the continuity of the charge transfer path, it is desirable to increase the bulk density through compression of lignocellulosic biomass samples for accurate moisture content measurement when the moisture content of lignocellulosic biomass using electrical resistance method is measured.

### Experimental Example 1-2: Moisture Content Analysis with Correction Factor Applied

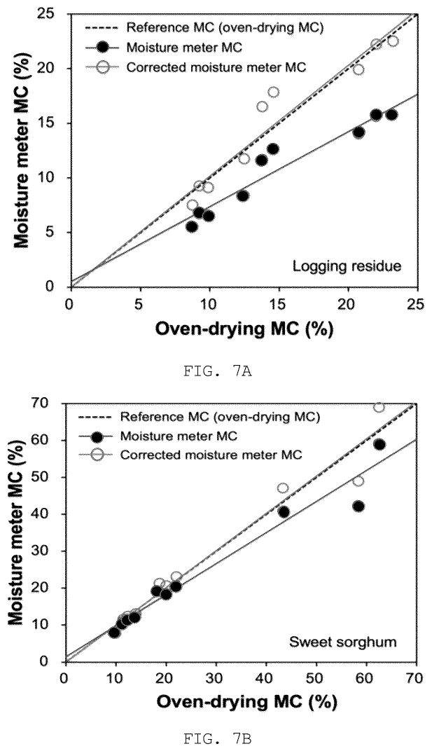

FIG. 7A is a graph showing the moisture content through the oven drying of the logging residue according to the Example 1 of the present disclosure, the moisture content through the moisture content meter and the moisture content through the moisture content meter to which the correction factor is applied. FIG. 7B is a graph showing the moisture content through the oven drying of the sweet sorghum according to the Example 1 of the present disclosure, the moisture content through the moisture content meter and the moisture content through the moisture content meter at the bulk density 0.32 g/cm³. Table 3 shows the correction factor and root mean square error (RMSE) data of the moisture content through a moisture content meter at a bulk density of 0.32 g/cm³ and the moisture content through oven drying according to Example 1 of the present disclosure. Referring to FIGS. 7A, 7B and Table 3, The RMSEs of the correction factors, 1.46 MC−0.51 for logging residue and 1.19 MC-1.42 for sweet sorghum, were reduced from 4.64 to 1.58 and from 5.33 to 3.96, respectively. By applying a correction factor to the MC measured by the moisture meter, the trend line of the corrected MC for both materials moved very close to the line of the reference MC by oven drying.

TABLE 3

| | Correction | RMSE | |
|---|---|---|---|
| Biomass | Factor | Original MC | Corrected MC |
| Logging | 1.46 MC − 0.51 | 4.64 | 1.58 |
| residue | | | |
| Sweet sorghum | 1.19 MC − 1.42 | 5.33 | 3.96 |

In Table 3, RMSE is the Root Mean Square Error, and MC is the Moisture Content measured by a moisture meter.

### Experimental Example 2: Electrical Resistance Analysis

### Experimental Example 2-1: Analysis of the Relationship Between Moisture Content and Electrical Resistance

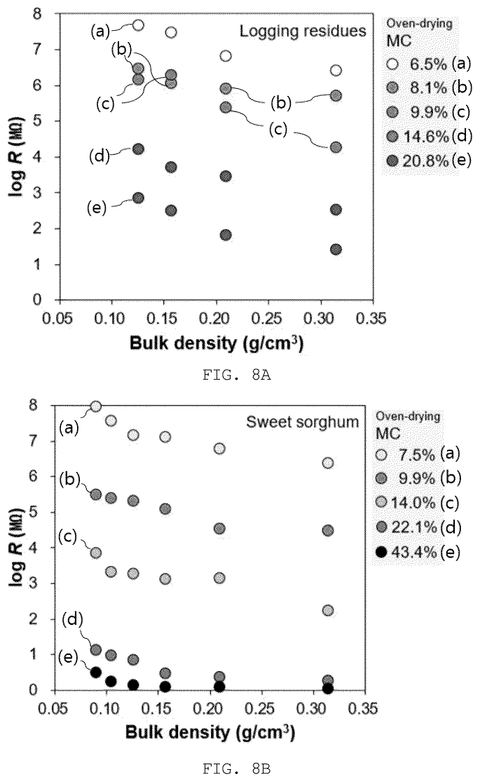

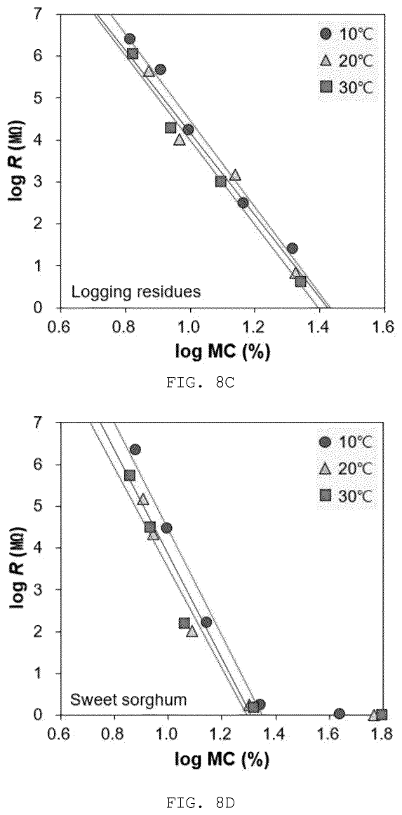

FIG. 8A is a graph dividing the electrical resistance of logging residue at 10° C. according to Example 2 of the present disclosure. FIG. 8B is a graph showing the electrical resistance of a sweet sorghum at 10° C. according to Example 2 of the present disclosure. FIG. 8C is a graph showing the change in the electrical resistance of the logging residue due to an increase in the volume density according to Example 2 of the present disclosure and the relation of the moisture content and electrical resistance. FIG. 8D is a graph showing the change in the electrical resistance of sweet sorghum and the relationship between moisture content and electrical resistance according to the increase in volume density according to Example 2 of the present disclosure. Table 4 below shows a simple linear regression equation between moisture content and electrical resistance below the fiber saturation point.

Referring to FIGS. 8A and 8B, an increase in MC resulted in a decrease in electrical resistance, and an increase in bulk density at a specific MC also caused a decrease in electrical resistance. As with the MC measurements, the increase in bulk density contributed to the creation of continuous paths for charge travel.

Further, referring to FIGS. 8C, 8D and Table 4, on a logarithmic scale, the relationship between the electrical resistance and MC was linear, with high coefficients of determination. However, the linear relationship was valid only below the FSP. For sweet sorghum, MC was higher than FSP due to excessive moisture absorption at 95% RH. Therefore, a linear relationship could not be established, suggesting that separate models below and above the FSP are required for sophisticated moisture determination based on the electrical resistance.

TABLE 4

| Biomass | Temperature (° C.) | Regression Equation | R² |
|---|---|---|---|
| Logging | 10 | log R(MΩ) = 14.765 − 10.316 log M | 0.984 |
| residue | 20 | log R(MΩ) = 9.843 − 14.009 log M | 0.962 |
| | 30 | log R(MΩ) = 10.104 − 14.098 log M | 0.989 |
| Sweet | 10 | log R(MΩ) = 17.611 − 13.106 log M | 0.986 |
| sorghum | 20 | log R(MΩ) = 15.944 − 12.253 log M | 0.965 |
| | 30 | log R(MΩ) = 15.613 − 11.967 log M | 0.956 |

In Table 4, R is the electrical resistance, M is the moisture content (%), and R² is the coefficient of determination.

### Experimental Example 2-2: Least Square Regression Model Prediction Analysis

Table 5 below is a table showing the prediction results of a general least squares regression model for the relationship between electrical resistance, moisture content, and temperature according to Example 2 of the present disclosure. Table 5 shows the prediction results of the ordinary least square regression models for the relationship among electrical resistance, MC, and temperature. The model prediction for logging residue achieved high performance, with an R² of 0.933 and RMSE of 0.505, whereas that for sweet sorghum was inferior, with an R² of 0.483 and RMSE of 1.657. However, in the limited MC range below the FSP, the model produced significantly improved performance, with R² and RMSE values of 0.833 and 0.891, respectively, suggesting that controlling the material's bulk density and MC range is essential for precisely determining the MC of biomass materials.

TABLE 5

| | MC | | | | | |
|---|---|---|---|---|---|---|
| | Range | | Calibration | | Prediction | |
| Biomass | (%) | Regression Equation | R² | RMSE | R² | RMSE |
| Logging | 5.4 to | log R(MΩ) = 8.202 − | 0.941 | 0.460 | 0.933 | 0.505 |
| residue | 22.0 | 0.334M − 0.012T | | | | |
| Sweet | 7.2 to | log R(Ω) = 4.340 − | 0.522 | 1.578 | 0.483 | 1.657 |
| sorghum | 62.5 | 0.092M + 0.005T | | | | |
| | 7.2 to | log R(MΩ) = 8.737 − | 0.902 | 0.669 | 0.833 | 0.891 |
| | 22.1 | 0.390M − 0.035T | | | | |

In Table 5, R is electrical resistance, M is moisture content (%), T is temperature (° C.), R² is coefficient of determination, and RMSE is root mean square error.

### Experimental Example 3: Multivariate Analysis of Near-Infrared (NIR) Spectral Data

### Experimental Example 3-1: NIR Spectral Characteristics Analysis

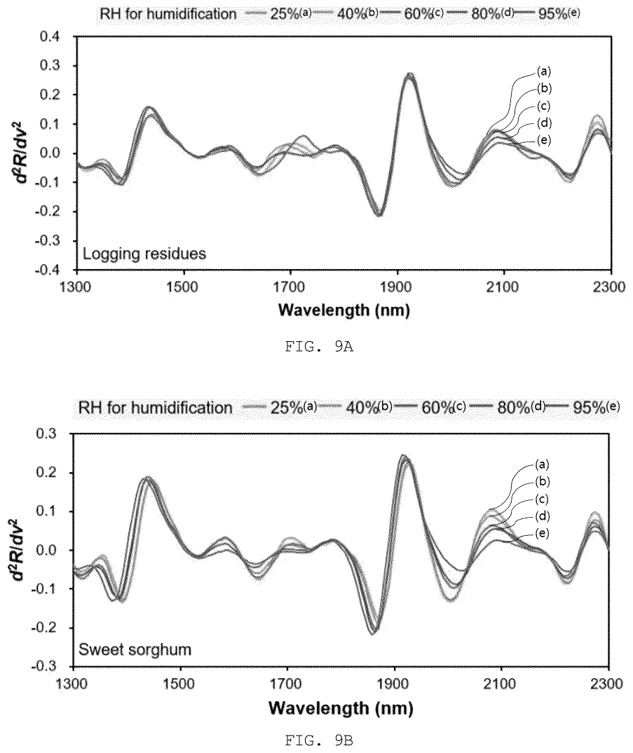

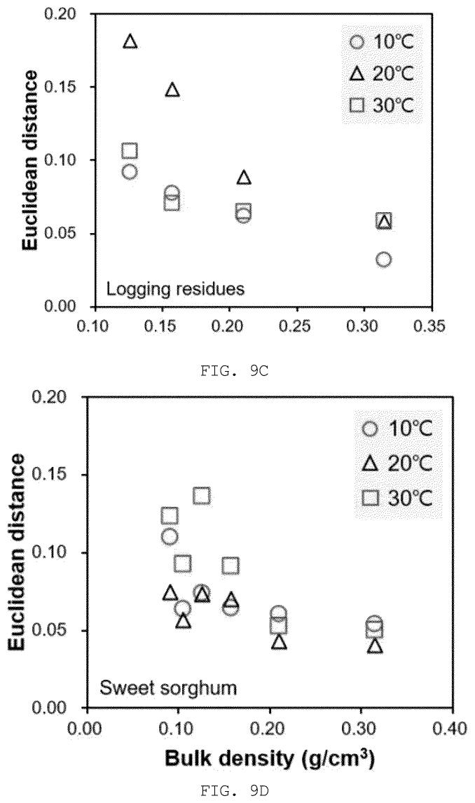

FIG. 9A is a graph showing the near-infrared spectrum of a sample of logging residue compressed to a bulk density of 0.32 g/cm³ at 20° C. in the domain of 1250 to 2300 nm according to Example 3 of the present disclosure, FIG. 9B is a graph showing the near-infrared spectrum of a sample of sweet sorghum compressed to a bulk density of 0.32 g/cm³ at 20° C. in the region of 1250 to 2300 nm according to Example 3 of the present disclosure, FIG. 9C is a graph showing the Euclidean distance between the near-infrared spectra measured three times at the angular density of logging residues according to Example 3 of the present disclosure, and FIG. 9D is a graph showing the Euclidean distance between the near-infrared spectra measured three times at each density of sweet sorghum according to Example 3 of the present disclosure.

Referring to FIGS. 9A and 9B, the 1437 and 1927 nm bands, with the two most prominent peaks in both materials, were assigned to water. The high humidification RH shifted the water peaks to the low-wavelength regions, and the band shift is attributable to changes in the mobility and binding force of water molecules due to changes in the water content. The spectral band at 1437 nm is rarely used for qualitative analysis but it may be helpful for quantitative purposes.

Also, referring to FIGS. 9C and 9D, the increase in bulk density decreased the Euclidean distance between the spectra measured in triplicate. Therefore, it was found that measuring the near-infrared spectrum at a bulk density of 0.21 g/cm³ or more is desirable for obtaining consistent near-infrared data of logging residues and sweet sorghum, and that the optimal lignocellulosic biomass density for improving the accuracy of the lignocellulosic biomass moisture content prediction is about 0.3 g/cm³.

### Experimental Example 3-2: Principal Component Analysis (PCA) and Outliers Analysis

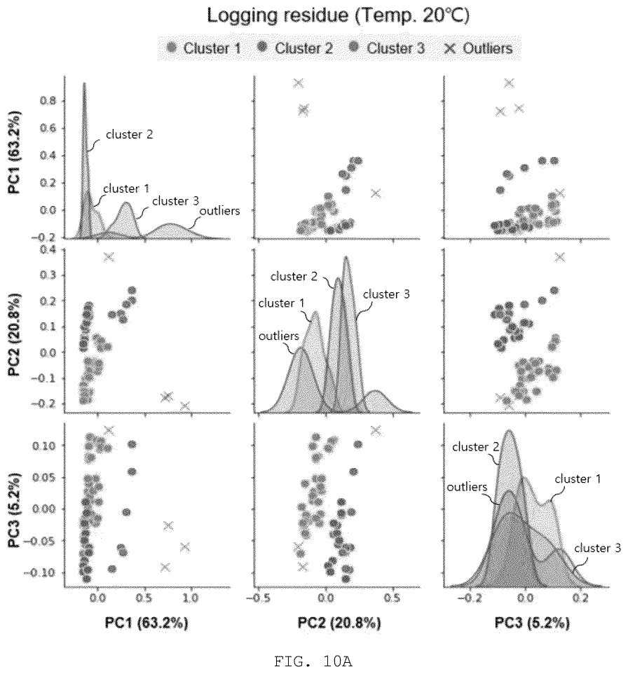

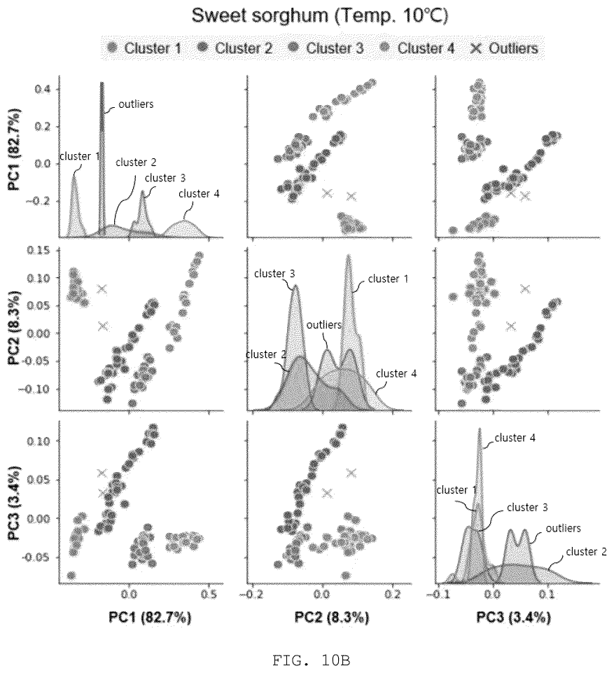

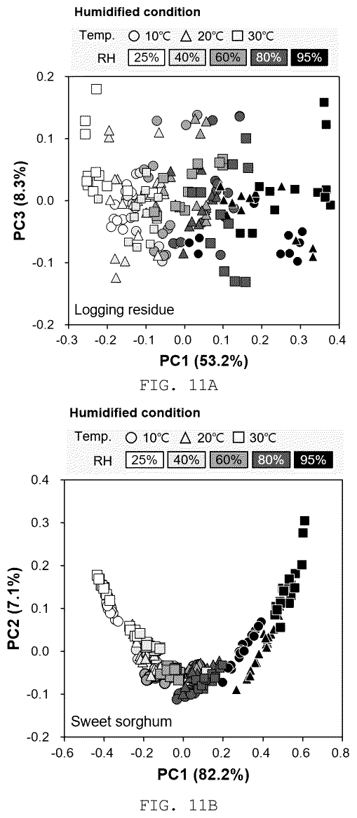

FIG. 10A is a graph representing a pair plot of the principal component (PC) scores clustered by DBSCAN for near-infrared data with outliers of logging residue according to Example 3 of the present disclosure, and FIG. 10B is a graph representing a pair plot of the principal component (PC) scores clustered by DBSCAN for near-infrared data with outliers of sweet sorghum according to Example 3 of the present disclosure.

In FIGS. 10A and 10B, the percentage values in parentheses of axis headings signify the dispersion factor of PC. Referring to FIGS. 10A and 10B, the clustering results of DBSCAN on the second-derivative NIR spectra of biomass materials were projected onto PC score plots. DBSCAN identified four data points from the NIR spectra of logging residues measured at 20° C. and two from sweet sorghum at 10° C. as outliers. The generation of outliers was attributed to poor scans due to incomplete contact between the NIR probe and the sample at low bulk densities. In the score plots, the outliers did not belong to a cluster and were spatially located far from the other clusters. Although not exactly consistent with the predefined RH conditions, the clusters were formed based on the moisture level. The effectiveness of DBSCAN for outlier detection on NIR data was verified by comparing the performance of models built with datasets with and without outliers for MC prediction, and the comparison is discussed in the subsection on the prediction model.

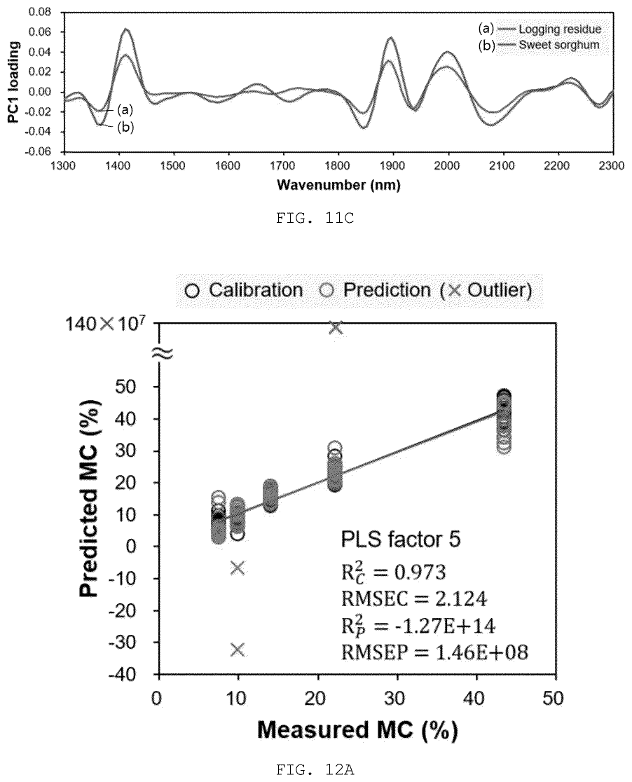

FIG. 11A is a graph dividing the near-infrared (NIR) spectra of logging residue according to Example 3 of the present disclosure and the principal component analysis (PCA) score plots of the two PCs at the loading of the first PC for the two materials, FIG. 11B is a graph representing the near-infrared (NIR) spectra of the sweet sorghum according to example 3 of the present disclosure and the principal component analysis (PCA) score plot of the two PCs at the loading of the first PC for the two materials, and FIG. 11C is a graph showing the loading of the first PC by near-infrared wavelength of logging residue and sweet sorghum according to Example 3 of the present disclosure. The percentages in parentheses in FIGS. 11a and 11b refer to the dispersion of each PC.

Referring to FIGS. 11A to 11C, in the score plots, data points were arranged for each RH condition along PC1 for both materials; the higher the MC, the higher the PC1 score. In the sweet sorghum score, the data points were grouped by temperature under humidification with a specific RH. The loading plots for the first PCs of logging residue and sweet sorghum suggest that the 1437 and 1927 nm bands reveal the moisture level of the materials. The band at 2087 nm, representing the 0-H stretching vibration of cellulose and hemicellulose, also had a moderate contribution.

### Experimental Example 3-3: Prediction Models for NIR Data

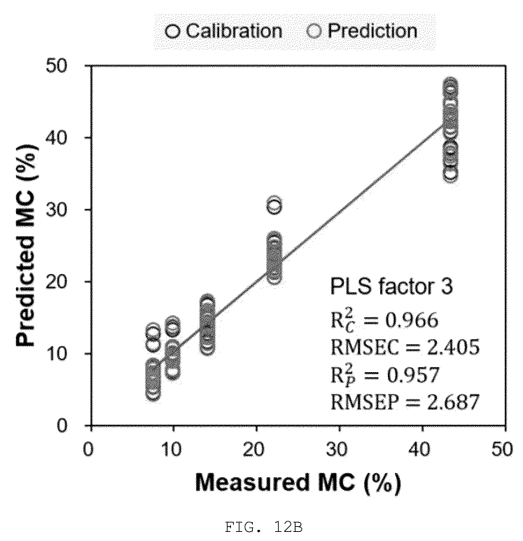

FIG. 12A is a graph showing the scatter plot of the moisture rate measured by the oven drying method at 10° C. for the sweet sorghum moisture prediction model constructed with near-infrared data according to Example 3 of the present disclosure, and FIG. 12B is a graph showing the scatter plot of the moisture content predicted by the partial least squares regression analysis (PLSR) model at 10° C. for no outliers according to Example 3 of the present disclosure. For reference, R^{2C} is the coefficient of determination for calibration, RMSEC is the root mean square error of calibration, R^{2P} is the predictive determination factor, RMSEP is the square root error for prediction, and outliers are statistical observations that are distinct from the rest of the sample.

Referring to FIGS. 12A and 12B, PLSR models built with the NIR spectra of logging residues and sweet sorghum were built for MC prediction. Outliers in the dataset significantly deteriorated the prediction ability of the model. In the MC prediction of a model built with NIR data with outliers, several data points (i.e., outliers) were far from the calibration line. In contrast, the prediction of a model built with data without outliers was similar to that of the calibration, with high R² and low RMSE values. These results imply the need for data preprocessing, such as outlier removal in building predictive models using NIR data and indicate that DBSCAN is an effective technique for detecting outliers in the NIR spectra.

### Experimental Example 3-4: Performance Analysis of PLS Regression Models

Table 6 below shows the performance of a partial minimal squares regression (PLSR) model constructed with a near-infrared spectrum for predicting the moisture content of lignocellulosic biomass according to Example 3 of the present disclosure. Referring to Table 6, spectral data processing using the second-derivative transform improved the predictions of the PLSR models. In all cases tested, models built with the second-derivative NIR spectra achieved higher R² and lower RMSE values with equal or lower PLS factors than those built with the original NIR spectra. The best MC prediction performance was achieved by a model built with NIR spectra measured for both materials.

The models built using the total NIR data measured at all temperatures also showed good prediction performance for both materials. The models built with the total NIR data of logging residue and sweet sorghum both achieved an R² of 0.942 or higher. These results suggest that PLSR models can predict the MC of biomass materials with high precision within a temperature range of 10 to 30° C., regardless of the band shift caused by temperature fluctuations. The construction of PLSR models with NIR spectra is a promising approach for determining the MCs of logging residue and sweet sorghum, irrespective of the change in moisture state within the temperature fluctuations tested. In addition, the models were established through k-fold cross-validation with datasets separated by the bulk density of the materials. This means that MC prediction is possible regardless of the bulk density of materials, in contrast to electrical resistance-based models. The NIR-based method that does not require material compaction is likely more promising for industrial applications as it allows online or inline measurements without disrupting the process flow. Because the prediction models determine local MCs, multi-point measurements are desirable for a more reliable evaluation. Additionally, the model predictions are valid within the MC range tested in this study. Hence, data and model updates should be preceded to determine the MC outside the range.

TABLE 6

| | Temperature | NIR | PLS | Calibration | | Prediction | |
|---|---|---|---|---|---|---|---|
| Biomass | (° C.) | Spectrum | Factor | R² | RMSE | R² | RMSE |
| Logging | Total | Original | 8 | 0.94 | 1.32 | 0.91 | 1.63 |
| residue | | 2^{nd} | 7 | 0.95 | 1.23 | 0.93 | 1.47 |
| | | Derivative | | | | | |
| | 10 | Original | 4 | 0.94 | 1.22 | 0.92 | 1.42 |
| | | 2^{nd} | 4 | 0.94 | 1.25 | 0.85 | 1.96 |
| | | Derivative | | | | | |
| | 20 | Original | 4 | 0.96 | 1.11 | 0.92 | 1.49 |
| | | 2^{nd} | 3 | 0.96 | 1.14 | 0.94 | 1.34 |
| | | Derivative | | | | | |
| | 30 | Original | 6 | 0.97 | 0.95 | 0.94 | 1.42 |
| | | 2^{nd} | 4 | 0.97 | 1.07 | 0.93 | 1.56 |
| | | Derivative | | | | | |
| Sweet | Total | Original | 6 | 0.97 | 3.06 | 9.65 | 3.36 |
| sorghum | | 2^{nd} | 6 | 0.97 | 2.99 | 0.97 | 3.33 |
| | | Derivative | | | | | |
| | 10 | Original | 5 | 0.98 | 1.85 | 0.97 | 2.40 |
| | | 2^{nd} | 3 | 0.93 | 3.37 | 0.91 | 3.86 |
| | | Derivative | | | | | |
| | 20 | Original | 7 | 0.99 | 1.71 | 0.98 | 2.51 |
| | | 2^{nd} | 4 | 0.99 | 2.14 | 0.97 | 3.04 |
| | | Derivative | | | | | |
| | 30 | Original | 6 | 0.98 | 2.58 | 0.97 | 3.49 |
| | | 2^{nd} | 6 | 0.98 | 2.60 | 0.98 | 3.18 |
| | | Derivative | | | | | |

In Table 6, PLS is the partial least squares, R² is the coefficient of determination, and RMSE is the root mean square error.

From the above, as the loose agglomeration of biomass fragments impedes the continuity of the charge transfer path, it was desirable to increase bulk density through material compression for precise moisture determination when using the electrical resistance method. The calculated correction factor reduced the root-mean-squared error (RMSE) of the commercial moisture meter for logging residues and sweet sorghum. The electrical resistance-based ordinary least squares regression (OLSR) models achieved better predictions for logging residues than sweet sorghum, and the performance of the models for both materials was valid below the fiber saturation point (FSP).

Also, the near infrared (NIR) spectra were stabilized at relatively sparse agglomeration of sample fragments, and the NIR-based models could predict the moisture content (MC) regardless of the bulk density of the materials. Data preprocessing by second derivative transformation and outlier removal on the NIR data improved the prediction performance of the models.

The scope of the present disclosure is defined by the following claims rather than the above detailed description, and all changes or modifications derived from the meaning and scope of the claims and their equivalent concepts should be interpreted as falling into the scope of the present disclosure.

What is claimed is:

1. A method of measuring a moisture content of lignocellulosic biomass, the method comprising:
(a) supplying a sample containing a lignocellulosic biomass;
(b) acquiring a near-infrared spectrum of the sample;
(c) mathematically preprocessing the near-infrared spectrum;
(d) constructing a moisture content prediction model by performing regression analysis on the preprocessed near-infrared spectrum with partial least square regression (PLSR); and
(e) obtaining a moisture content of the sample using the moisture content prediction model.

2. The method of claim 1, wherein the lignocellulosic biomass comprises a fragmented lignocellulosic biomass.

3. The method of claim 1, wherein the lignocellulosic biomass comprises one or more types selected from the group consisting of logging residue and sweet sorghum.

4. The method of claim 1, wherein the step (c) comprises:
(c-1) obtaining a second derivative spectrum data by applying a second-derivative method to the near-infrared spectrum.

5. The method of claim 4, wherein step (c) further comprises:
(c-2) taking measured wavelength gap (nm) of the near-infrared spectrum as any one of 1 to 10 nm and smoothing the near-infrared spectrum,
wherein the step (c-2) is performed after the step (c-1).

6. The method of claim 5, wherein the smoothing is performed using moving average method with 11 points.

7. The method of claim 1, wherein the step (d) comprises:
(d-1) obtaining a moisture content prediction model by performing regression analysis on mathematically preprocessed near-infrared spectrum with partial least squares regression (PLSR) method; and
(d-2) constructing a verified moisture content prediction model by validating the moisture content prediction model.

8. The method of claim 7, wherein the verifying of the step (d-2) is performed by K-fold cross validation.

9. The method of claim 8, wherein the number of folds in step (e) is in a range of 2 to 6.

10. The method of claim 1, wherein the method further comprises:
(a′) compressing the lignocellulosic biomass to prepare a compacted lignocellulosic biomass with a predetermined density,
wherein the step (a′) is performed before the step (a).

11. The method of claim 10, wherein the density is in a range of 0.1 to 0.5 g/cm³.

12. The method of claim 1, wherein the method further comprises:
(b′) the procedure to obtain the corrected spectrum data by deleting outlier from the near-infrared spectral data,
wherein the step (b′) is performed after the step (b).

13. The method of claim 12, wherein the outlier of step (b′) is data that does not belong to a cluster and exists outside of the cluster in principal component analysis (PCA).

14. A sample compressor for measuring a moisture content of lignocellulosic biomass comprising:
a compression part which has cylinder shape, and comprises a body with a hollow oriented longitudinally;
a detection part which is longitudinally oriented in the middle of the body, and comprises a near-infrared probe; and
a plurality of sample fixing parts which are located inside of the hollow and are oriented longitudinally around the detection part.

15. The sample compressor of claim 14, wherein the body comprises a through hole which penetrates the hollow and outside thereof, and the sample fixing part comprises a piston, a spring and a fixing pin.

16. The sample compressor of claim 15, wherein the piston comprises a protrusion, and the spring is compressed when the piston moves into the direction of the sample containing the lignocellulosic biomass, and the protrusion is drawn into the through hole, and fixed.

17. The sample compressor of claim 16, wherein the sample fixing parts are moved in the opposite direction of the direction of the sample by elastic force of the spring when the protrusion is discharged from the trough hole and jam is removed.

18. The sample compressor of claim 15, wherein the fixing pin is connected to one end of the piston, and is longitudinally located in the internal hollow of the spring.

19. The sample compressor of claim 15, wherein the spring is impregnated in the lignocellulosic biomass and fixes the lignocellulosic biomass when the spring is compressed.

20. The sample compressor of claim 14, wherein the near-infrared probe comprises a light source fiber and a light absorbing fiber, and the light absorbing fiber to absorb the light reflected from the sample.
